(19) United States
(12) Patent Application Publication
(10) Pub. No.: US 2015/0025800 A1
(43) Pub. Date: Jan. 22, 2015

(54) Method for Monitoring Vehicle Driving State and Vehicle Navigation Device for Achieving the Same

(71) Applicant: Robert Bosch GmbH, Stuttgart (DE)

(72) Inventor: Jian An, Suzhou (CN)

(21) Appl. No.: 14/336,927

(22) Filed: Jul. 21, 2014

(30) Foreign Application Priority Data
Jul. 22, 2013 (CN) 201310308241.8

(51) Int. Cl. G01C 21/26

(52) U.S. Cl. CPC G01C 21/26
USPC 701/523

(57) ABSTRACT

A method for monitoring a vehicle driving state, includes obtaining a first image for a scene in front of a vehicle so as to recognize a lane the vehicle currently travels in, obtaining a second image having a driving-restriction board, and recognizing, from the board, driving-restriction information for a region where the vehicle is currently in. The method further includes determining whether a vehicle driving state and the driving-restriction information match, and generating a message for warning if the vehicle driving state and the driving-restriction information do not match.

### FIELD OF THE INVENTION

The present invention relates to vehicle navigation technology, in particular, to a method for monitoring a vehicle driving state and a vehicle navigation device for achieving the method.

### BACKGROUND

For road traffic, both the number and severity of traffic accidents will rise with an increase of vehicle speed. Experiences in various countries demonstrate that with each increase of 1 kilometer/hour of average vehicle speed, the damage of traffic accidents will increase by 3%, and deadly traffic accidents will increase by 4%-5%. Overspeed of driving has already become a main reason of the occurrence of traffic accidents in each country of the world. Therefore, the control over vehicle speed is very important for improving safety in traffic road and reducing the occurrence of traffic accidents.

Currently, each country has different regulations and measurements for limiting road speed according to actual circumstances thereof. Moreover, even in the same country, the limited speed value for road varies dynamically for different hours and different regions. For example, a reasonable safety limited value (also referred to as variable speed control) is often set for a highway based on such conditions as road condition, traffic condition and weather condition, etc. In addition, when setting a safety limited speed, such factors as vehicle type and lane are also taken into consideration.

The limited speed information is typically displayed on an information board disposed on a road or aside of a road so that the driver can be notified in time. However, due to such factors as non-concentration of attention, retarded reaction and poor sight, these restriction information might be ignored or misunderstood, thus placing the vehicle into an unsafe driving state. For example, the vehicle might travel in a fast lane at a lower speed or in a slow lane at a faster speed, might travel in a lane for which the vehicle is prohibited, and might exceed a limited speed temporarily set due to various emergencies, etc.

The driving trace for a vehicle can be detected by means of satellite locating signals such as GPS, thus enabling a real time monitoring for vehicle driving state. However, in order to support this method, a vast database storing geographic and traffic information is required, making this method highly dependent on the accuracy and timely update of the data.

In view of the above, a method that can accurately and reliably monitor vehicle driving state in an automatic manner is required, in which the driver can be immediately notified of an unsafe driving state of a vehicle once it is monitored by the method, thus eliminating safety hazard.

### SUMMARY OF THE INVENTION

The object of the invention is to provide a method for monitoring a vehicle driving state which presents such advantages as being accurate, reliable and timely.

The method for monitoring a vehicle driving state according to an embodiment of the invention comprises the steps of:
obtaining a first image for a scene in front of a vehicle so as to recognize which lane the vehicle currently travels in;
obtaining a second image having a driving-restriction board;
recognizing, from the board, driving-restriction information for a region where the vehicle is currently in;
determining whether the vehicle driving state and the driving-restriction information match; and
if it does not match, generating a message for warning.

In the above embodiment, the monitoring of vehicle driving state is realized by useing images which are taken locally. Therefore, both the accuracy and reliability are improved as compared to the prior art.

Preferably, in the above method, the driving-restriction information is a defined relationship among lane, vehicle type and driving speed restriction.

Preferably, in the above method, the first image and the second image are obtained by a first camera and a second camera, wherein the first camera is disposed at a middle position of the head of the vehicle, and the second camera is disposed at a middle position of an upper portion of the front windshield of the vehicle.

Preferably, in the above method, the step of obtaining a second image having a driving-restriction board comprises the steps of:
activating the second camera when it is determined that the vehicle is spaced apart from the driving-restriction board by a first set distance;
obtaining the second image when it is determined that the vehicle is spaced apart from the driving-restriction board by a second set distance; and
deactivating the second camera when the acquisition of the second image is completed, wherein the first set distance is larger than the second set distance, and the distance between the vehicle and the driving-restriction board is determined by means of a navigation device.

Since the recognition of the driving-restriction information is activated only when the vehicle is close to the board, the resource consumed by computing devices can be greatly reduced.

Preferably, in the above method, the driving-restriction information is recognized in the following manner:
if it is determined that it is currently in a foggy weather condition according to the concentration degree of pixel gray values of the second image, performing an enhanced process to the second image;
extracting a region corresponding to the driving-restriction board from the second image which has been subject to the enhanced process; and
recognizing the driving-restriction information from the region corresponding to the driving-restriction board.

Preferably, in the above method, the enhanced process comprises the steps of:
dividing a value range of the pixel gray values of the second image into a plurality of gray threshold intervals, each gray threshold interval corresponding to a foggy weather category;
determining the foggy weather category according to the distribution of the pixel gray values of the second image in the plurality of gray threshold intervals; and
employing a corresponding enhanced processing algorithm for processing second images that belong to different foggy weather categories.

Since different enhanced processing algorithms are used to process the second images of different foggy weather categories, a better pertinency is obtained, thus significantly improving the accuracy in recognizing driving-restriction information.

Further, it the above method, the foggy weather categories comprise three categories of light fog, dense fog and thick fog, wherein for the light fog category, the Frankle-McCann algorithm is used for enhanced process; for the dense fog category, the contrast enhanced algorithm is used for enhanced process; and for the thick fog category, the enhanced process is performed in the following manner: firstly, a demeaning and unit variance operation is performed on the second image, then a lateral column vector is demeaned and normalized into a unit variance, and lastly, a denoising operation is performed using sparse coding.

Another object of the invention is to provide a vehicle navigation device which monitor vehicle driving state accurately, reliably and timely.

The vehicle navigation device according to an embodiment of the invention comprises:
a unit for receiving locating signal, configured to receive locating signal from one or more satellites;
a display; and
a processing unit coupled to the unit for receiving locating signal and the display,
configured to process the locating signal and rendering navigation information on the display,
be characterized in further comprising an image unit coupled to the processing unit, the image unit comprising:
   an image acquisition device, configured to obtain a first image for a scene in front of a vehicle and a second image having one or more driving-restriction boards;
   an image processing device, configured to recognize which lane the vehicle currently travels in and to recognize, from the board, driving-restriction information for a region where the vehicle is currently in,
      the processing unit is further configured to determine whether a vehicle driving state and the driving-restriction information match, and to generate a message for warning and render the message on the display if it does not match

Preferably, in the above vehicle navigation device, the image acquisition device comprises:
a first camera configured for obtaining the first image, which is disposed at a middle position of the head of the vehicle; and
a second camera configured for obtaining the second image, which is disposed at a middle position of an upper portion of the front windshield of the vehicle.

Preferably, in the above vehicle navigation device, a wide angle range and a horizontal shooting angle of the first camera is about 140 degrees and −10 degrees respectively, and a wide angle range and a horizontal shooting angle of the second camera is about 140 degrees and +20 degrees respectively.

### BRIEF DESCRIPTION OF THE DRAWINGS

The above and/or other aspects and advantages of the invention will become more clear and more easily understood from the following description of many aspects with reference to the accompanying drawings, in which identical or similar elements are denoted by identical reference signs, the accompanying drawings comprising:

FIG. 1, which is a block view showing the structure of a vehicle navigation device according to an embodiment of the invention;

FIG. 2, which is an overall flowchart of a method for monitoring a vehicle driving state according to an embodiment of the invention; and

FIG. 3 is a flowchart showing an image enhanced process routine for the method shown in FIG. 2.

### LIST OF REFERENCE SIGNS

10 vehicle navigation device
110 unit for receiving locating signal
120 display
130 storage
140 image unit
141 image acquisition device
141A first camera
141B second camera
142 image processing device
150 processing unit

### DETAILED DESCRIPTION OF THE INVENTION

The invention will be described more fully hereinafter with reference to the accompanying drawings which illustrate exemplary embodiments of the invention. However, the invention can be embodied in many different ways and should not be considered as being merely limited to the embodiments provided herein. The above embodiments provided herein are intended to make the disclosure of the application thorough and complete so as to enable a more complete and accurate understanding of the scope of protection of the invention.

Such expressions as “including” and “comprising” are used to indicate that in addition to the elements and steps that have been directly and definitely expressed in the Description and claims, the technical solutions of the invention do not exclude other cases involving other elements and steps that are not mentioned directly or definitely.

Such expressions as “first” and “second” are not used to identify the order of elements in terms of time, space, dimension, etc.; rather, they are used merely for distinguishing elements from each other.

The embodiments of the invention will be described in detail with reference to the accompanying drawings.

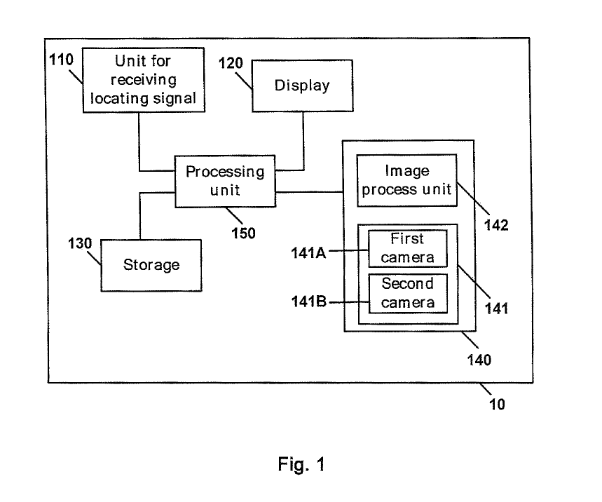

FIG. 1 is a block view showing the structure of a vehicle navigation device according to an embodiment of the invention.

As shown in FIG. 1, the vehicle navigation device 10 comprises a unit 110 for receiving locating signal, a display 120, a storage 130, an image unit 140 and a processing unit 150 coupled to the above units.

In this embodiment, the unit 110 for receiving locating signal receives a satellite signal from a satellite positioning system such as Global Positioning System (GPS) and Beidou satellite navigation system. Navigation data is stored in the storage 130 to be used by the processing unit 150. The processing unit 150 determines information on current location of the vehicle according to the received satellite signal and generates navigation information in combination with the navigation data. The generated navigation information is displayed on the display 120 so as to be used by users.

In addition to the above navigation data, the storage 130 stores a control program and other data (e.g., vehicle model number) for achieving the navigation function and a vehicle driving state monitoring function to be described below.

With reference to FIG. 1, the image unit 140 comprises an image acquisition device 141 and an image processing device 142.

In this embodiment, the image acquisition device 141 comprises a first camera 141A and a second camera 141B which are used for obtaining a first image for a scene in front of a vehicle and a. second image having one or more driving-restriction boards respectively. In order to obtain a clear mage for a scene in front of the vehicle, the first camera 141A is preferably provided at a. middle position of the head of the vehicle and has a wide angle range and a horizontal shooting angle of about 140 degrees and −10 degrees respectively. The first camera 141A can be in a continuous operational state. Optionally, the first camera 141A can be activated periodically so as to obtain a scene in front of the vehicle. In other embodiments, the image acquisition device 141 can comprise only one camera for obtaining a first image for a scene in front of a vehicle and a second image having one or more driving-restriction boards.

The driving-restriction boards are generally located on the road or aside of the road. The second camera 141B is preferably provided at a middle position of an upper portion of the front windshield of the vehicle and has a wide angle range and a horizontal shooting angle of about 140 degrees and +20 degrees respectively. The advantage resulting from providing the second camera 141B at the above location is that, on one hand, the image of the driving-restriction boards taken at this location is substantially consistent with that viewed from driver's eyes, and on the other hand, the sight of the driver will not be blocked.

In this embodiment, the second camera 141B preferably operates in an activated mode. Specifically, when the processing unit 150 determines that the vehicle is spaced apart from a driving-restriction board in front of the vehicle at a set distance (e.g., 100 meters) according to the locating signal and navigation data, it instructs the image unit 140 to enter the second camera 141B into an operational state. Then, when the processing unit 150 determines that the vehicle is spaced apart from the driving-restriction board at another set distance (e.g., 20 meters) according to the locating signal and navigation data, it instructs the image unit 140 to obtain a second image by the second camera 141B. When the acquisition of image is completed, the processing unit 150 instructs the image unit 140 to deactivate the second camera 141B or enter the second camera 141B into a standby state.

It is noted that the “driving-restriction” mentioned herein should not be construed in a narrow sense to be merely speed restriction; rather, it should be construed in a broad sense to be various restrictions on vehicle driving, including but not limited to: the restriction on the lane in which the vehicle travels in, an upper limit and a lower limit of driving speed, restriction on driving direction, restriction on vehicle type and one or more combinations of the above restrictions, etc. For example, in an exemplary embodiment, the following driving-restriction information may be applied to a segment of road having three one-way driving lanes:
(1) Only small passenger cars are allowed to travel in the outer lane at a driving speed between 100 km/h-120 km/h;
(2) Both passenger cars and trucks are allowed to travel in the middle lane at a driving speed between 80 km/h-100 km/h; and
(3) Both passenger cars and trucks are allowed to travel in the inner lane at a driving speed between 60 km/h-80 km/h.

The image processing device 142 is coupled to the image acquisition device 141. The image processing device 142 serves to extract relevant information from the acquired first image and second image so as to be used by the processing unit 150. For example, for the first image for a scene in front, of the vehicle obtained by the first camer 141A, the image processing device 142 firstly recognizes a lane line from the image, and then determines which lane the vehicle currently travels in accordingly. Also for the second image having one or more driving-restriction boards obtained by the second camer 141B, the image processing device 142 firstly extracts this image from the board region, and then recognizes numbers, characters or signs included in the board region, thus obtaining driving-restriction information. Preferably, before performing the above process on the second image, the image processing device 142 firstly performs an enhanced process on the image so as to improve accuracy of recognition. The method concerning enhanced process will be further described below.

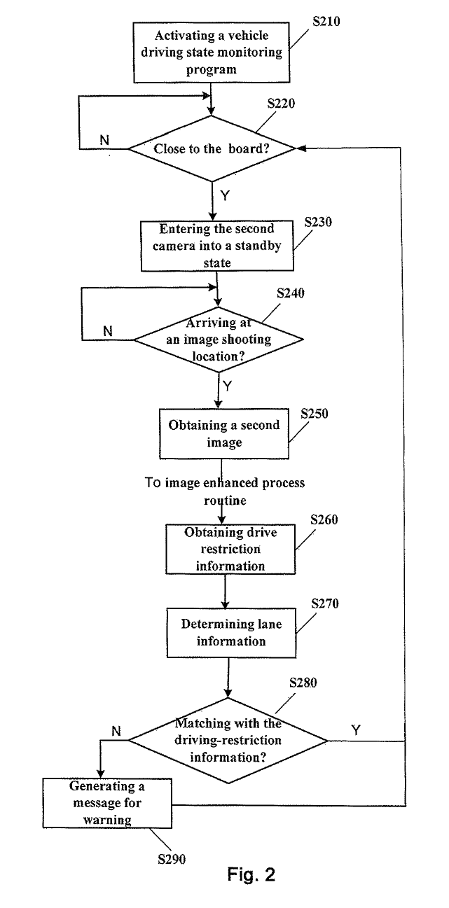

FIG. 2 is an overall flowchart of a method for monitoring a vehicle driving state according to an embodiment of the invention. For convenience of description, it is assumed herein that the method according to the embodiment is implemented by means of the vehicle navigation device shown in FIG. 1. However, it is noted that the principle of the invention is not limited to a navigation device of a particular type and structure.

As shown in FIG. 2, at step S210, the processing unit 150 of the vehicle navigation device 10, in response to a user's command to enter an operational mode of monitoring a vehicle driving state, activates a vehicle driving state monitoring program by instructing the image unit 140 to obtain an image for a scene in front of the vehicle by using the first camer 141A.

Then, step S220 is executed, in which the processing unit 150 obtains information on current location of the vehicle according to the satellite signal received by the unit 110 for receiving locating signal, and determines whether the vehicle is close to the driving-restriction board in combination with the navigation data (e.g., by determining whether the vehicle is spaced apart from the board by a first set distance). If it is determined that the vehicle is close to the board, step S230 is executed; otherwise, execution of the above step S220 of determining is continued.

At step S230, the processing unit 150 instructs the image unit 140 to enter the second camer 141B into a standby state so as to be ready for obtaining an image of driving-restriction boards. Then step S240 is executed, in which the processing unit 150 determines whether the vehicle has arrived at an image shooting location using information on current location of the vehicle obtained by the satellite signal and the navigation data (e.g., by determining whether the vehicle is spaced apart from the board by a second set distance). If it is determined that the vehicle has arrived at the image shooting location, step S250 is executed, in which the second camer 141B obtains an image of the driving-restriction board and then is deactivated; otherwise, execution of the above step S240 of determining is continued.

After step S250, the method shown in FIG. 2 proceeds with an image enhanced process routine which will be described in detail below. In this routine, it is determined whether the second image obtained by the second camer 141B needs an enhanced process or not. Such en enhanced process is executed when necessary.

After the completion of the image enhanced process routine, step S260 is executed, in which the image processing device 142 will recognize the second image or the second image which has been subject to the enhance process so as to obtain drive restriction information and provide the drive restriction information to the processing unit 150. In this embodiment, the drive restriction information is a defined relationship among lane, vehicle type and driving speed restriction and can be stored in the storage 130 in the form of a table so as to be used by the processing unit 150. It should be pointed out that the drive restriction information in this embodiment is merely illustrative rather than limiting, and can comprise various restrictions on vehicle driving.

Table 1 is an exemplary table showing drive restriction information.

TABLE 1

| | | Range of Speed | |
|---|---|---|---|
| Lane | Vehicle Type | Upper Limit (km/h) | Lower Limit (km/h) |
| 1 | small passenger car | 100 | 80 |
| 1 | large passenger car | 100 | 80 |
| 1 | truck | 100 | 80 |
| 2 | large passenger car | 80 | 60 |
| 2 | truck | 80 | 60 |
| 3 | truck | 80 | 60 |
| 3 | dangerous vehicle | 60 | 40 |

Then, step S270 is executed, in which the image processing device 142 determines which lane the vehicle currently travels in according to the first image obtained by the first camera 141A and provides the result to the processing unit 150.

Then, step S280 is executed, in which the processing unit 150 determines whether the current vehicle driving state matches with the driving-restriction information obtained by the image processing device 142 at the above step S260; if they match, the method returns to the step S220; otherwise, the method proceeds with the step S290, in which the processing unit 150 generates a message for warning so that the driver is informed of an inappropriate driving state of the vehicle, and the information can be displayed on the display 120 in a visual manner and/or presented in an acoustical signal.

In step S280, the current vehicle driving state comprises the lane the vehicle currently travels in, vehicle type and current driving speed of vehicle, wherein the lane is determined by the image processing device 142 at the above step S270, the vehicle type can be set by the user himself or set by vehicle manufactures before the vehicle leaves the factory, and the current driving speed of vehicle can be obtained from an external sensor.

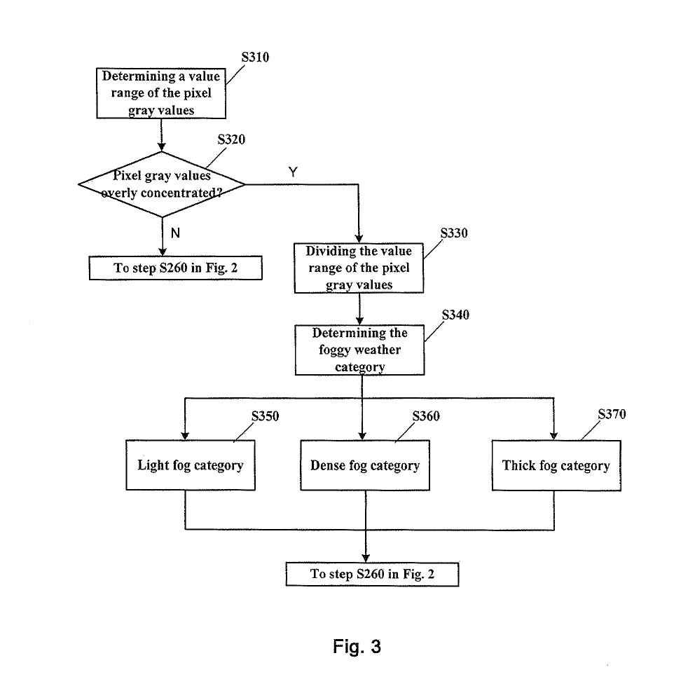

FIG. 3 is a flowchart showing an image enhanced process routine for the method shown in FIG. 2.

As shown in FIG. 3, at step S310, the image processing device 142 determines a value range of the pixel gray values of the second image and thus obtains a distribution of the pixel gray values.

Then, step S320 is executed, in which the image processing device 142 determines whether the pixel gray values are overly concentrated according to the distribution of the pixel gray values obtained (e.g., by determining whether there exists such a pixel gray value window, a proportion of the number of pixels contained in which to the total number of pixels is larger than a preset threshold. If it is determined that the pixel gray values are overly concentrated, step S330 is executed for performing an image enhanced process; otherwise, no image enhanced process is performed and the step S260 in FIG. 2 is executed directly.

At step S5330, the image processing device 142 divides the value range of the pixel gray values into a plurality of gray threshold intervals according to a plurality of set gray threshold values, each gray threshold interval corresponding to a foggy weather category. By way of example, the foggy weather category comprises three categories of light fog, dense fog and thick fog.

Then, step S340 is executed, in which the image processing device 142 determines the foggy weather category at the time of obtaining images according to a distribution of pixel gray values in the above plurality of intervals. For example, a foggy weather category corresponding to an interval having a maximum degree of overlap with the above pixel gray value window can be determined as the foggy weather category at the time of obtaining the second image.

Then, steps S350, S360 and S370 are executed in an alternative way according to the foggy weather category determined at step S340. Specifically, for light fog category, step S350 is executed, in which the image processing device 142 uses Frankle-McCann algorithm for enhanced processing of the second image; for dense fog category, step S360 is executed, in which the image processing device 142 uses contrast enhanced algorithm for enhanced processing of the second image; and for thick fog category, step S370 is executed, in which the image processing device 142 performs the enhanced processing in the following manner: firstly, a demeaning and unit variance operation is performed on the second image, then a lateral column vector is demeaned and normalized into a unit variance, and lastly, a denoising operation is performed using sparse coding.

After the completion of executing steps S350, S360 and S370 in an alternative way, the image enhanced process routine shown in FIG. 3 will execute step S260 shown in FIG. 2.

While some aspects of the invention have been illustrated and discussed, it will be appreciated by those skilled in the art that these aspects can be modified without departing from the principle and spirit of the invention. Therefore, the scope of the invention will be defined by the appended claims and equivalents thereof.

1. A method for monitoring a vehicle driving state, comprising:
obtaining a first image for a scene in front of a vehicle so as to recognize a lane the vehicle currently travels in;
obtaining a second image having a driving-restriction board;
recognizing, from the board, driving-restriction information for a region where the vehicle is currently in;
determining whether a vehicle driving state and the driving-restriction information match; and
generating a message for warning if the vehicle driving state and the driving-restriction information do not match.

2. The method according to claim 1, wherein the driving-restriction information is a defined relationship among lane, vehicle type and driving speed restriction.

3. The method according to claim 1, wherein:
the first image and the second image are obtained by a first camera and a second camera,
the first camera is disposed at a middle position of a head of the vehicle, and
the second camera is disposed at a middle position of an upper portion of a front windshield of the vehicle.

4. The method according to claim 3, wherein:
obtaining the second image having the driving-restriction board includes
activating the second camera when it is determined that the vehicle is spaced apart from the driving-restriction board by a first set distance,
obtaining the second image when it is determined that the vehicle is spaced apart from the driving-restriction board by a second set distance, and
deactivating the second camera when acquisition of the second image is completed,
the first set distance is larger than the second set distance, and
a distance between the vehicle and the driving-restriction board is determined by a navigation device.

5. The method according to claim 1, wherein recognizing the driving-restriction information includes:
performing an enhanced process to the second image if it is determined that the vehicle is currently in a foggy weather condition according to a concentration degree of pixel gray value of the second image;
extracting a region corresponding to the driving-restriction board from the second image which has been subject to the enhanced process; and
recognizing the driving-restriction information from the region corresponding to the driving-restriction board.

6. A vehicle navigation device, comprising:
a signal unit configured to receive a locating signal from one or more satellites;
a display;
a processing unit coupled to the signal unit and the display, the processing unit configured to process the locating signal and to render navigation information on the display; and
an image unit coupled to the processing unit, the image unit including
an image acquisition device configured to obtain a first image for a scene in front of a vehicle and a second image having one or more driving-restriction boards, and
an image processing device configured to recognize which lane the vehicle currently travels in and to recognize, from the board, driving-restriction information for a region where the vehicle is currently in,
wherein the processing unit is further configured (i) to determine whether a vehicle driving state and the driving-restriction information match, and (ii) to generate a message for warning and render the message on the display if the vehicle driving state and the driving-restriction information do it does not match.

7. The vehicle navigation device according to claim 6, wherein the driving-restriction information is a defined relationship among lane, vehicle type and driving speed restriction.

8. The vehicle navigation device according to claim 6, wherein the image acquisition device comprises:
a first camera configured to obtain the first image, the first camera disposed at a middle position of a head of the vehicle; and
a second camera configured to obtain the second image, the second camera disposed at a middle position of an upper portion of a front windshield of the vehicle.

9. The vehicle navigation device according to claim 8, wherein:
a wide angle range and a horizontal shooting angle of the first camera is about 140 degrees and −10 degrees respectively, and
a wide angle range and a horizontal shooting angle of the second camera is about 140 degrees and +20 degrees respectively.

10. The vehicle navigation device according to claim 8, wherein the second camera obtains the second image according to the following process under the control of the processing unit:
the processing unit activates the second camera when the processing unit determines that the vehicle is spaced apart from the driving-restriction board by a first set distance according to the locating signal;
the second camera obtains the second image when the processing unit determines that the vehicle is spaced apart from the driving-restriction board by a second set distance according to the locating signal; and
the processing unit deactivates the second camera when the acquisition of the second image is completed,
wherein the first set distance is larger than the second set distance.

11. The vehicle navigation device according to claim 6, wherein the image processing device recognizes the driving-restriction information according to the following process:
performing an enhanced process to the second image if the image processing device determines that the vehicle is currently in a foggy weather condition according to a concentration degree of pixel gray value of the second image;
extracting a region corresponding to the driving-restriction board from the second image which has been subject to the enhanced process; and
recognizing the driving-restriction information from the region corresponding to the driving-restriction board.
